(19) United States
(12) Patent Application Publication
(10) Pub. No.: US 2014/0306871 A1
(43) Pub. Date: Oct. 16, 2014

(54) DUAL GATE DRIVING LIQUID CRYSTAL DISPLAY DEVICE

(71) Applicant: CHUNGHWA PICTURE TUBES, LTD., Bade City (TW)

(72) Inventors: Chia-yi LU, Bade City (TW); Hsin-hung TSAI, Sihu Township (TW)

(21) Appl. No.: 13/938,914

(22) Filed: Jul. 10, 2013

(30) Foreign Application Priority Data
Apr. 16, 2013 (TW) 102206906

(51) Int. Cl. G09G 3/36

(52) U.S. Cl. CPC G09G 3/3614; G09G 3/3648
USPC 345/96

(57) ABSTRACT

A dual gate driving LCD device comprises a liquid crystal panel, a gate driving module, a source driving module, and an electric charge sharing unit. The liquid crystal panel comprises several pixels. The gate driving module comprises a plurality of scan lines connected to the pixels to control switching the pixels on or off. The source driving module comprises a plurality of data lines connected to a plurality of the pixels and charges the pixels by positive and negative polarity voltages and the adjacent data lines outputting voltages with different polarities at the same time. The electric charge sharing unit is connected to the source driving module and performs electric charge sharing of the voltage with different polarities between two adjacent data lines before charging the pixels to neutralize the electric charge for each of the pixels to make a charging time the same.

### CROSS-REFERENCE TO RELATED APPLICATION

This application claims priority from and the benefit under 35 U.S.C. §119(a) of Taiwanese Patent Application No. 102206906, filed on Apr. 16, 2013 in the TIPO (Taiwan Intellectual Property Office), which is hereby incorporated by reference for all purposes as if fully set forth herein.

### BACKGROUND OF THE INVENTION

1. Field of the Invention

The present invention relates to a dual gate driving type of liquid crystal display device and more particularly relates to a liquid crystal display device adapted for dual gate driving.

2. Description of Prior Art

A liquid crystal display (LCD) device has become one of indispensable products in modern society and used in many different fields, for example, information technology products such as a computer, a mobile phone and so on.

Please refer to FIG. 1 and FIG. 2. FIG. 1 is a schematic diagram illustrating a conventional dual gate driving LCD device, and FIG. 2 illustrates a pixel array in the conventional dual gate driving LCD device. As shown in the drawings, an LCD device 100 comprises a gate driving module 110, a source driving module 120, and a liquid crystal panel 130. The liquid crystal panel 130 comprises a plurality of pixels. The gate driving module 110 comprises a plurality of scan lines GO1˜GOn electrically connected to the pixels, and the pixels in the same row are driven by two scan lines. For example, the scan lines GO1 and GO2 are together to drive the pixels in the same row. The source driving module 120 comprises a plurality of data lines SO1˜SOn electrically connected to the pixels and each of the data lines drives two adjacent pixels at the same time. As shown in FIG. 2, as to the pixels in the row are driven by the scan lines GO1 and GO2; the data line SO1 drives the pixels P1 and P2, as to the pixels are driven by the scan lines GO3 and GO4 in the row, the data line SO1 drives the pixels P3 and P4, and the rest can be deduced accordingly. By using the dual gate driving method, the usage quantity of the data lines SO1˜SOn is efficiently reduced.

The data line SO1 drives the pixels P1, P2, P3, P4 and P5 by switching the positive and negative polarity voltages once every two pixels. That is, the positive polarity voltage is used to drive the pixel P1, and the negative polarity voltage is used to drive the pixels P2 and P3. Thereafter, the positive polarity voltage is used to drive the pixels P4 and P5 and so on.

However, when the positive polarity voltage is switched to be the negative polarity voltage, for example, the polarity of the signal in the pixels P1 and P2 is switched. Hence, the pixel P2 is undercharged, and the polarity of the signal between the pixels P2 and P3 is not switched. Therefore, the pixel P3 is charged to be in the steady state. Similarly, the same problem would happen to the pixel P4. Thus, the previous pixel in the two pixels with the same polarity voltage will be undercharged and a vertical stripe is existed on the liquid crystal panel because the luminance between the adjacent pixels is different to result in inconvenience for the users.

Therefore, it is a problem required to be solved immediately, and a method or device is developed to overcome the drawbacks described above.

### SUMMARY OF THE INVENTION

Accordingly, the present invention is to solve the foregoing conventional technique problem and one object thereof is to provide a dual gate driving LCD device. Therefore, the pixels in the LCD device can have the same charging time and the problem of the generation of the vertical stripes, which is inconvenience for the users, can be avoided.

For achieving the above-mentioned object, the present invention proposes a dual gate driving LCD device comprising a liquid crystal panel, a gate driving module, a source driving module and an electric charge sharing unit. The liquid crystal panel comprises a plurality of pixels. The gate driving module comprises a plurality of scan lines respectively connected to a plurality of the pixels to control switching the pixels on or off. The source driving module comprises a plurality of data lines respectively connected to a plurality of the pixels and the source driving module charges the pixels by a positive polarity voltage and a negative polarity voltage and the adjacent data lines outputting voltages with different polarities at the same time. The electric charge sharing unit is electrically connected to the source driving module and configured for performing electric charge sharing of the voltage with different polarities between two adjacent data lines before the pixel is charged, and the electric charge in each of the pixels is neutralized to make a charging time for each of the pixels the same.

Another object of the present invention is to provide a dual gate driving LCD device to solve the problem that the vertical line generated by the different luminance of two adjacent pixels. Therefore, the charging time in each of the pixels is the same.

According to the object above, the present invention proposes a dual gate driving LCD device comprising a liquid crystal panel, a gate driving module, a source driving module and an electric charge sharing unit. The liquid crystal panel comprises a plurality of pixels. The gate driving module comprises a plurality of scan lines respectively connected to the pixels to switch the pixels on or off. The source driving module comprises a plurality of data lines respectively connected to the pixels and configured for charging the pixels with a positive polarity voltage and a negative polarity voltage as part of the pixels are turned on, the adjacent data lines outputting the voltages with different polarities at the same time. The electric charge sharing unit is electrically connected to the source driving module and configured for performing electric charge sharing of the voltage with different polarities between two adjacent data lines before the pixel is charged, and the electric charge in each of the pixels is neutralized to make a charging time in each of the pixels the same to synchronize a charging time for each of the pixels, and the electric charge sharing unit can output a first electric charge control signal and a second electric charge control signal. When the electric charge sharing unit outputs the first electric charge control signal, the electric charge sharing is activated for each of the scan lines and when the electric charge sharing unit outputs the second electric charge control signal, every two of the scan lines activates the electric charge sharing.

Therefore, the present invention can maintain the charging time of the pixels in the LCD device is all the same. The problem that the luminance is varied because the charging time of the pixel is different to generate several bright and dark vertical stripes on the LCD device to result in inconvenience for the users can be avoided.

### BRIEF DESCRIPTION OF THE DRAWINGS

FIG. 1 is a diagram illustrating the conventional dual gate driving liquid crystal display (LCD) device;

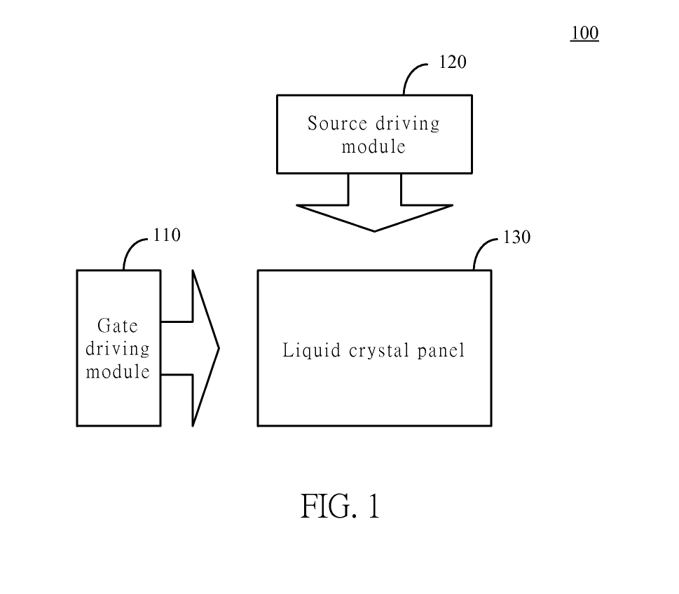

FIG. 2 is a pixel array diagram illustrating the conventional dual gate driving LCD device;

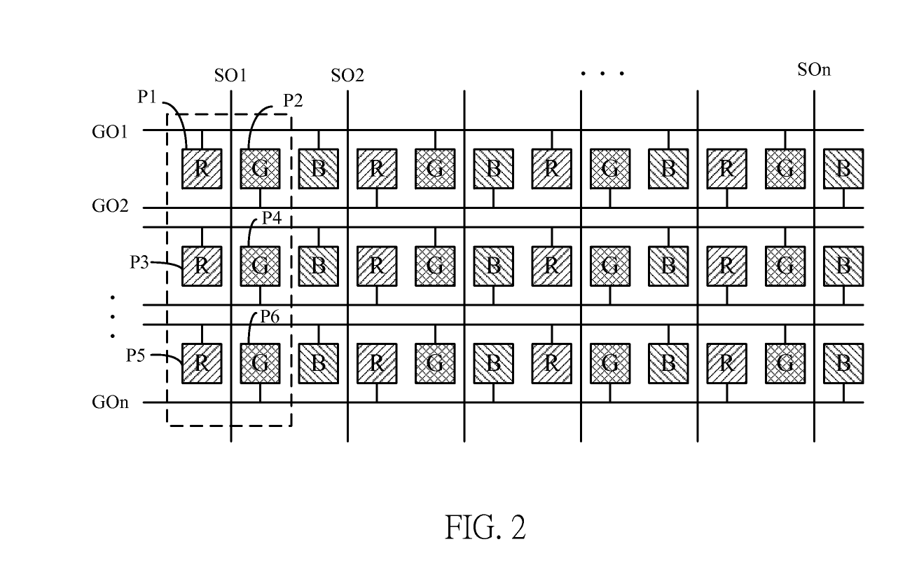

FIG. 3 is a circuit block diagram illustrating an LCD device in an embodiment of the present invention;

FIG. 4 is a pixel array diagram illustrating the LCD device in the embodiment of the present invention;

FIG. 5 is a circuit block diagram illustrating the source driving module in the embodiment of the present invention;

FIG. 6 is a time sequence diagram illustrating the electric charge sharing control signal in the embodiment of the present invention; and

FIG. 7 is a time sequence diagram illustrating the pixel charging status in the embodiment of the present invention.

### DETAILED DESCRIPTION OF THE INVENTION

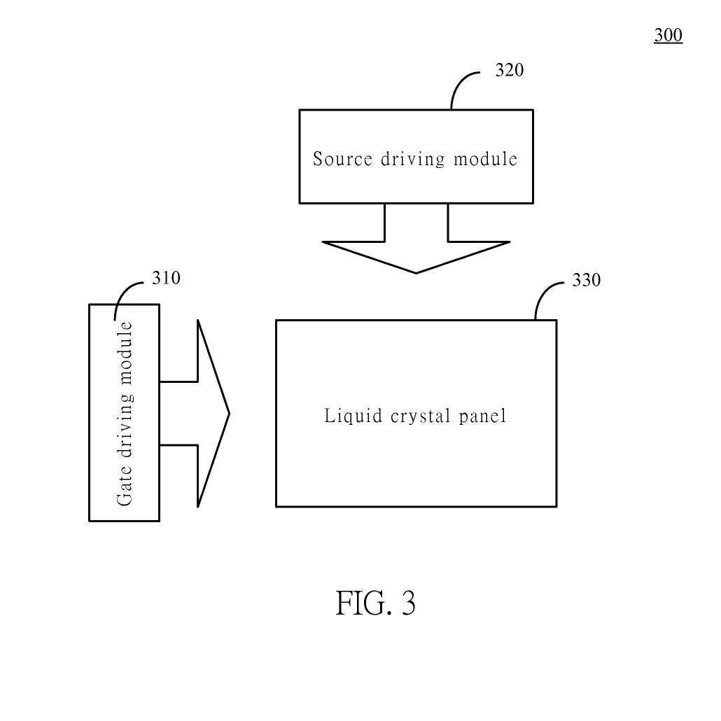

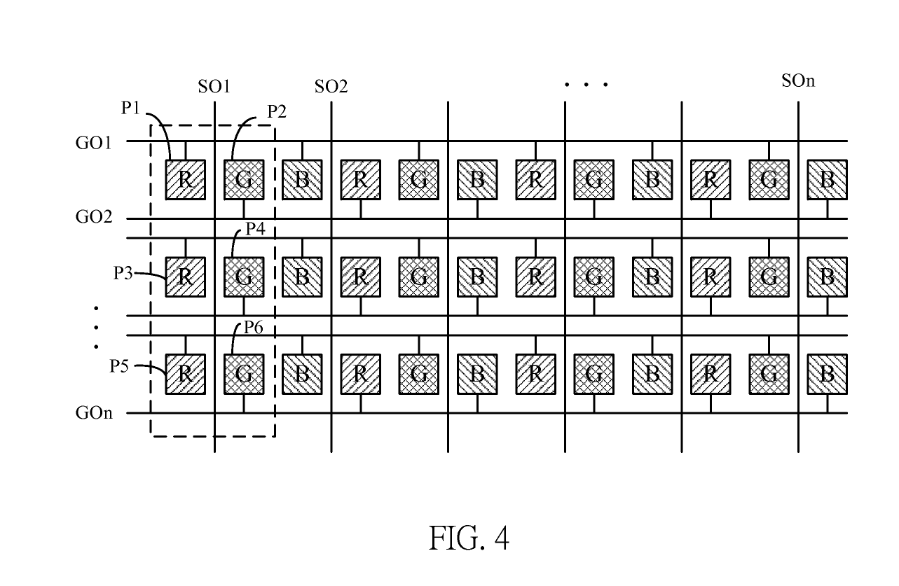

Please refer to FIG. 3 and FIG. 4, FIG. 3 is a circuit block diagram illustrating an LCD device in an embodiment of the present invention, and FIG. 4 is a pixel array diagram illustrating the LCD device in the embodiment of the present invention. As shown in FIG. 3, the LCD device 300 in the present embodiment comprises a gate driving module 310, a source driving module 320 and a liquid crystal panel 330 comprising plural of pixels. The gate driving module 310 comprises a plurality of scan lines GO1˜GOn electrically connected to the pixels and the pixels in the same row are driven by two scan lines. For example, the scan lines GO1 and GO2 are together to drive the pixels in the same row. Accordingly, the crystal liquid device 300 with dual gate driving is formed herein. The source driving module 320 comprises a plurality of data lines SO1˜SOn electrically connected to the pixels and each of the data lines can drive two adjacent pixels simultaneously, As shown in FIG. 4, as the pixels driven by the scan lines GO1 and GO2 in the row, the data line SO1 drives the pixels P1 and P2; as the pixels driven by the scan lines GO3 and GO4 in the row, the data line SO1 drives the pixels P3 and P4 and the rest can be deduced accordingly. By a dual gate driving method, it is efficiency to reduce the quantities of the data lines SO1˜SOn.

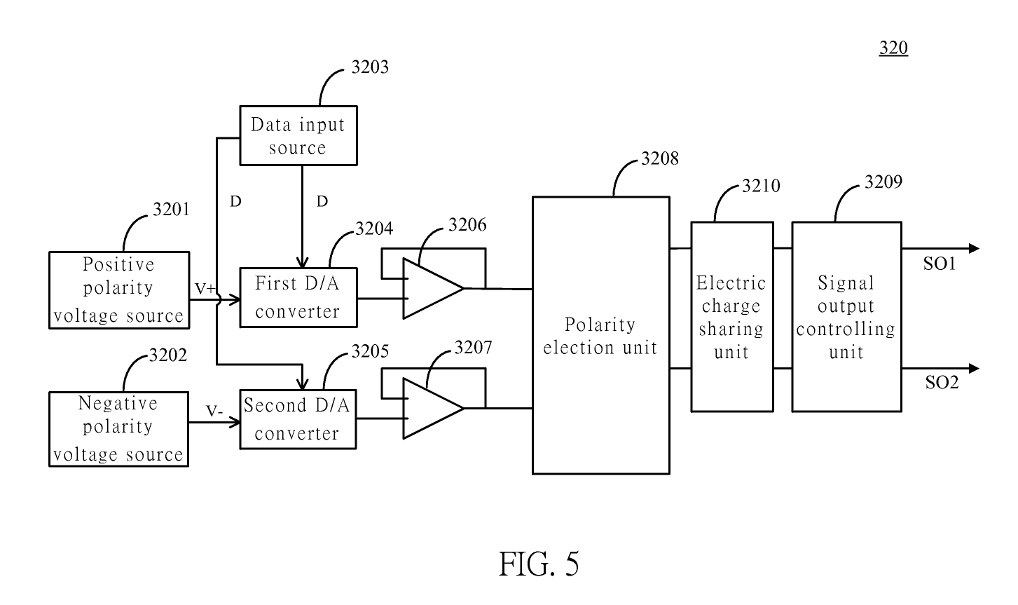

Please refer to FIG. 5, and FIG. 5 is a circuit block diagram illustrating the source driving module in the embodiment of the present invention. As shown in drawing, the first data line SO1 and the second data line SO1 are described herein and the rest of the data lines SO3˜SOn can be derived accordingly. The source driving module 320 comprises a positive polarity voltage source 3201, a negative polarity voltage source 3202, a data input source 3203, a first digital-to-analog (D/A) converter 3204, a second D/A converter 3205, a first operational amplifier 3206, a second operational amplifier 3207, a polarity selection unit 3208, a signal output controlling unit 3209 and an electric charge sharing unit 3210. In the present embodiment, the positive polarity voltage source 3201 is electrically connected to the first D/A converter 3204 and the first D/A converter 3204 is electrically connected to the first operational amplifier 3206. The first operational amplifier 3206 is electrically connected to the polarity selection unit 3208. The negative polarity voltage source 3202 is electrically connected to the second D/A converter 3205 and the second D/A converter 3205 is electrically connected to the second operational amplifier 3207. The second operational amplifier 3207 is electrically connected to the polarity selection unit 3208. The data input source 3203 is respectively connected to the first D/A converter 3204 and the second D/A converter 3205.

In the present embodiment, the first D/A converter 3204 is configured for converting a data D inputted by the data input source 3203 and a positive polarity voltage V+ inputted by the positive polarity voltage source 3201 from a digital mode to an analog mode, and the signal thereof is amplified by the first operational amplifier 3206 and transmitted to the polarity selection unit 3208. The second D/A converter 3205 is configured for converting the data D inputted by the data input source 3203 and the negative polarity voltage V− inputted by the negative polarity voltage source 3202 from digital to analog, and the signal thereof is amplified by the second operational amplifier 3207 and transmitted to the polarity selection unit 3208.

In the present embodiment, the polarity selection unit 3208 can select the amplified positive polarity voltage and data or the amplified negative polarity voltage and data to transmit to the signal output controlling unit 3209. Subsequently, the signal is selectively outputted to the first data line SO1 or the second data line SO2 by the signal output controlling unit 3209 to achieve the operation that each of the data lines can switch between the positive polarity voltage and the negative polarity voltage. The voltages outputted from the first data line SO1 and the second data line SO2 at the same time are different polarities. When the first data line SO1 outputs the positive polarity voltage, the second data line SO2 outputs the negative polarity voltage.

In the present embodiment, the electric charge sharing unit 3210 is disposed between the polarity selection unit 3208 and the signal output controlling unit 3209 and the electric charge sharing unit 3210 is indirectly connected between the first data line SO1 and the second data line SO2. Before the data line will charge the pixels, the electric charge sharing unit 3210 will share the electric charges between the first data line SO1 and the second data line SO2 and the electric charges in the pixels are neutralized by the input of the voltages with different polarities. Accordingly, the previous charged pixel can be discharged quickly. The electric charge sharing is stopped and the next pixel can start to be charged after the previous charged pixel is discharged completely. Therefore, the charging time for each of the pixels is the same.

In some embodiments, the electric charge sharing unit 3210 can be disposed outside of the source driving module 320. In other words, the device without the electric charge sharing unit 3210 can install the electric charge sharing unit 3210 outside of the source driving module 320 to increase the convenient for the users.

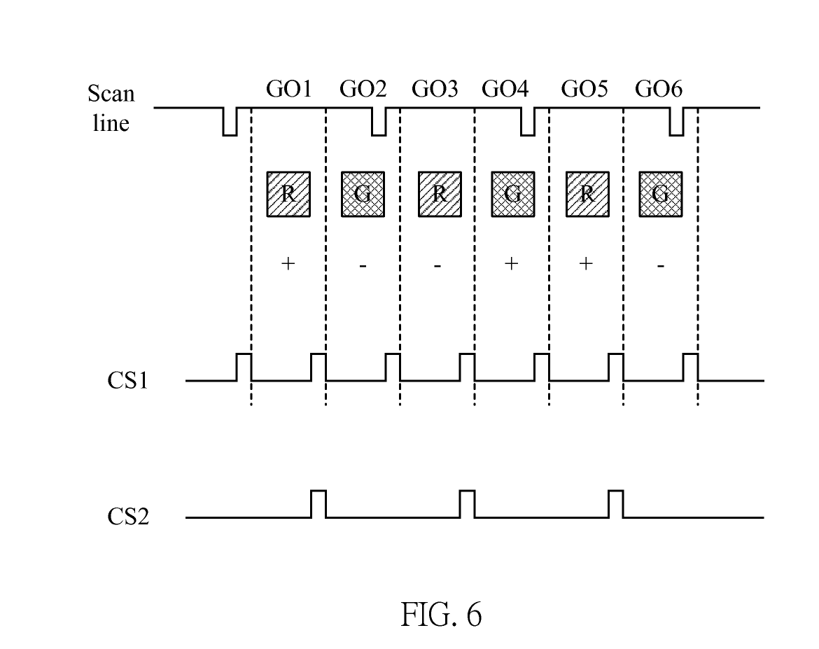

Please refer to FIG. 5 in conjunction with FIG. 6. FIG. 6 is a time sequence diagram illustrating the electric charge sharing control signal in the embodiment of the present invention. The electric charge control signal outputted by the electric charge sharing unit 3210 can be divided into a first electric charge control signal CS1 and a second electric charge control signal CS2. When the electric charge sharing unit 3210 outputs the first electric charge control signal CS1, the electric charge sharing is activated for each of the scan lines. Each of the scan lines starting the electric charge sharing is to neutralize the electric charges with the same polarities or different polarities, for example the positive polarity converting into the negative polarity (GO1->GO2) or the negative polarity converting into the positive polarity (GO2->GO1). When the electric charge sharing unit 3210 outputs the second electric charge control signal CS2, every two of the scan lines will start the electric charge sharing, for example the positive polarity converting into the negative polarity (GO1->GO2). According to the application of the panel characteristics, the electric charge sharing unit 3210 electively outputs the first electric charge control signal CS1 or the second electric charge control signal CS2 to solve the problem that the vertical line is generated by the different luminance in the adjacent pixels. Therefore, the charging time when the pixel reached to the steady status is the same.

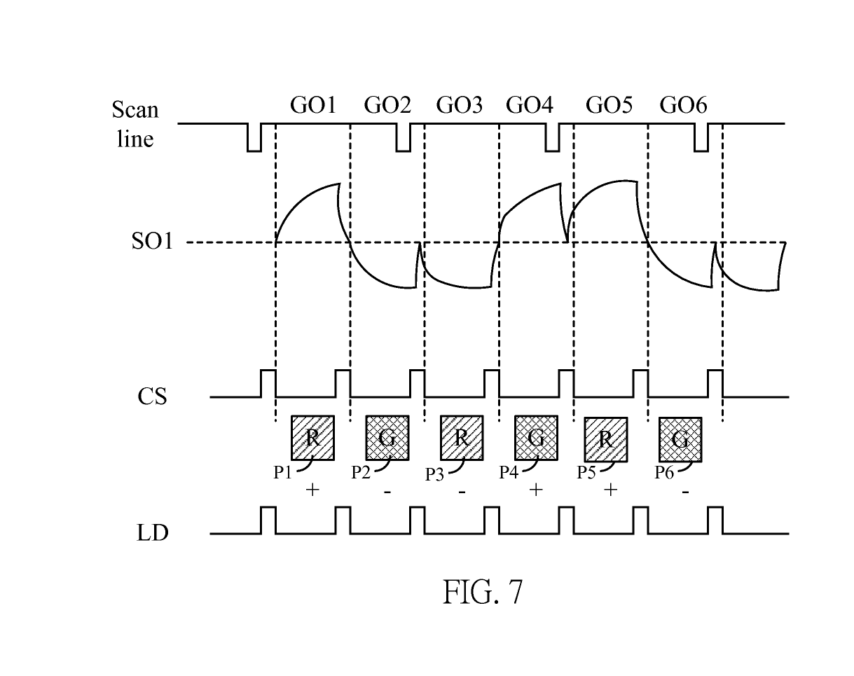

Please refer to FIG. 7 in conjunction with FIG. 4 and FIG. 5. FIG. 7 is a time sequence diagram illustrating the pixel charging status in the embodiment of the present invention. The description herein implements the first data line SO1 as the example. As shown in FIG. 4, the pixels charged by the first data line SO1 are pixels P1˜P6. In the present embodiment, the pixel P1 is charged by the positive polarity voltage, the pixel P2 is charged by the negative polarity voltage, the pixel P3 is charged by the negative polarity voltage, the pixel P4 is charged by the positive polarity voltage, the pixel P5 is charged by the positive polarity voltage and the pixel P6 is charged by the negative polarity voltage. Accordingly, the positive polarity voltage and the negative polarity voltage are switched once between every two pixels.

In the present embodiment, the pixels P1˜P6 are driven by the scan line and then the signal output controlling unit 3209 of the source driving module 320 selectively inputs the positive polarity voltage or the negative polarity voltage to the pixels P1˜P6 through the first data lines SO1. As shown in FIG. 7, the electric charge sharing unit 3210 outputs the electric charge sharing signal CS and the signal output controlling unit 3209 outputs a signal output control signal LD. When the electric charge sharing signal CS is a relatively high logic voltage, the signal output control signal LD is also a relatively high logic voltage. At this moment, the first scan line SO1 starts to charge the pixel P1 with a positive polarity voltage and the pixel P1 is charged from the zero voltage level. When the electric charge sharing signal CS is the relatively high logic voltage once again, the first data line SO1 will charge the pixel P2 with a negative polarity voltage. At this moment, the positive polarity and the negative polarity charges are shared between the first data line SO1 and the second data line SO2. The negative polarity voltage is introduced into the pixel P1 and the charging waveform of the pixel P1 is quickly returned to zero voltage level (discharging is done). At this moment, the first data line SO1 can charge the pixel P2. When the electric charge sharing signal CS is the relatively high logic voltage once again, the charging waveform of the pixel P2 is quickly returned to zero voltage level and the first data line SO1 will charge the pixel P3 with a negative polarity voltage. When electric charge sharing signal CS is the relatively high logic voltage once again, the charging waveform of the pixel P3 is quickly returned to zero voltage level and the first data line SO1 will charge the pixel P4 with the positive polarity voltage. The pixel P5 and P6 are also charged in the same method above.

In summary, according to the electric charge sharing unit in the present invention, the charging time in each of the pixels is the same to achieve that the luminance is the same. Therefore, the problem that the luminance is varied because the charging time in the pixels is different to generate several bright and dark vertical stripes on the LCD device to result in inconvenience for the users can be avoided.

What is claimed is:

1. A dual gate driving liquid crystal display device comprising:
a liquid crystal panel having a plurality of pixels;
a gate driving module having a plurality of scan lines respectively connected to the pixels for controlling switching the pixels on or off;
a source driving module having a plurality of data lines respectively connected to the pixels, and when a portion of the pixels are switched on, the source driving module charging these pixels by a positive polarity voltage and a negative polarity voltage, and the adjacent data lines outputting voltages with different polarities at the same time; and
an electric charge sharing unit electrically connected to the source driving module and configured for performing electric charge sharing of the voltages with different polarities between two adjacent data lines before charging the respective pixels to neutralize electric charges in each of the pixels and to make a charging time for each of the pixels the same.

2. The dual gate driving liquid crystal display device according to claim 1, wherein the pixels in the same row are driven by two of the scan lines.

3. The dual gate driving liquid crystal display device according to claim 2, wherein the source driving module processes and then inputs the positive polarity voltage, the negative polarity voltage and data into the pixels.

4. The dual gate driving liquid crystal display device according to claim 1, wherein the electric charge sharing unit is disposed in the source driving module.

5. A dual gate driving liquid crystal display device comprising:
a liquid crystal panel having a plurality of pixels;
a gate driving module having a plurality of scan lines respectively connected to the pixels for controlling switching the pixels on or off;
a source driving module having a plurality of data lines respectively connected to the pixels, the source driving module charging the pixels by a positive polarity voltage and a negative polarity voltage, and the adjacent data lines outputting the voltages with different polarities at the same time; and
an electric charge sharing unit electrically connected to the source driving module and configured for performing electric charge sharing of the voltages with different polarities between two adjacent data lines before charging the pixels to neutralize the electric charge in each of the pixels to make a charging time for each of the pixels the same, and the electric charge sharing unit outputting a first electric charge control signal and a second electric charge control signal;
wherein the electric charge sharing is activated for each of the scan lines, when the electric charge sharing unit outputs the first electric charge control signal, and the electric charge sharing is activated for every two of the scan lines, when the electric charge sharing unit outputs the second electric charge control signal.

6. The dual gate driving liquid crystal display device according to claim 5, wherein the pixels in the same row are driven by two of the scan lines.

7. The dual gate driving liquid crystal display device according to claim 5, wherein the source driving module processes and then inputs the positive polarity voltage, the negative polarity voltage and data to the pixels.

8. The dual gate driving liquid crystal display device according to claim 5, wherein the electric charge sharing unit is disposed in the source driving module.

9. The dual gate driving liquid crystal display device according to claim 5, wherein the electric charge sharing activated for each of the scan lines is to neutralize the electric charge with the same polarities or different polarities.

10. The dual gate driving liquid crystal display device according to claim 5, wherein the electric charge sharing activated for every two of the scan lines is to neutralize the electric charge with different polarities.
